(19) United States
(12) Patent Application Publication
(10) Pub. No.: US 2015/0088321 A1
(43) Pub. Date: Mar. 26, 2015

(54) Self-Learning Closed-Loop Control Valve System

(71) Applicant: Bray International, Inc., Houston, TX (US)

(72) Inventors: Jim Schmidt, Houston, TX (US); Steve Drollinger, Milwaukee, WI (US); Ekank Jatwani, Houston, TX (US)

(21) Appl. No.: 14/495,473

(22) Filed: Sep. 24, 2014

Related U.S. Application Data
(60) Provisional application No. 61/881,828, filed on Sep. 24, 2013.

(51) Int. Cl. G05B 13/02; G05D 7/06; F16K 1/22

(52) U.S. Cl. CPC G05B 13/02; F16K 1/22; G05D 7/0635
USPC 700/282

(57) ABSTRACT

A pressure independent control valve system including a pipe system defining a flow path for a volume of fluid to regulate flow downstream of the pressure independent control valve system, wherein the pipe system has a butterfly valve configured to control a flow rate of the volume of fluid; an ultrasonic sensor configured to transmit and receive a signal across the flow path; and an electronic transducer processor in data communication with the ultrasonic sensor and the butterfly valve.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

Technical field: Valve systems are used in heating, ventilation, and air-cooling (HVAC) pipe systems, including in regard to pressure independent control valves used to regulate and maintain the fluid flow rate and/or energy use/transfer of said pipe systems.

Conventional pressure-independent control or energy valves rely on the use of magnetic flow meters or sensors for measuring flow and ball valves for controlling flow. Such systems often have low accuracy levels because magnetism-based sensors can fail to function properly due to debris, metal, or wayward ferrous materials in the pipe system while the ball valves require special characterization to accurately control flow. Further, such systems may rely on the use of ball valves to modulate the flow of fluid which are expensive to manufacture and thus increases the overall costs of these valve systems. In addition, at certain pipe diameters, ball valves as implemented into prior systems may become prohibitively expensive to produce for a piping system.

Thus, a need exists for a lower cost, and higher-accuracy alternative to the traditional pressure independent control valve systems.

### BRIEF SUMMARY OF THE EMBODIMENTS

An adaptive and/or self-learning, predictive, and based upon known C, characteristics, closed loop control butterfly valve system, apparatus, and method for the purpose of regulating or maintaining a predetermined flow rate and/or energy usage/transfer, including a pipe system defining a flow path for a volume of fluid to regulate flow downstream of the pressure independent control valve system, wherein the pipe system has a butterfly valve configured to control a flow rate of the volume of fluid; an ultrasonic sensor configured to transmit and receive a signal across the flow path; and an electronic transducer processor in data communication with the ultrasonic sensor and the butterfly valve.

As used herein, “Cᵥ” is defined as the volume of water in U.S.G.P.M. (U.S. gallons per minute) that will flow through a given restriction or valve opening with a pressure drop of one (1) p.s.i. (pound per square inch) at room temperature. “Cᵥ characteristic” may be expressed as and is inclusive of values, coefficients, and plotted curves or curves.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic side, elevation view of one embodiment of a self-correcting closed loop control valve system.

FIG. 2 depicts a cross sectional view of one embodiment of an ultrasonic flow sensor arrangement for use in a self-correcting closed loop control valve system.

FIG. 3 depicts a cross sectional view of an alternative embodiment of an ultrasonic flow sensor arrangement for use in a self-correcting closed loop control valve system.

FIG. 4 depicts a schematic view of a butterfly valve for use in a self-correcting closed loop control valve system.

FIG. 5 depicts a block diagram of an embodiment of data storage, input, collection and processing for output in the self-correcting closed loop control valve system.

### DETAILED DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

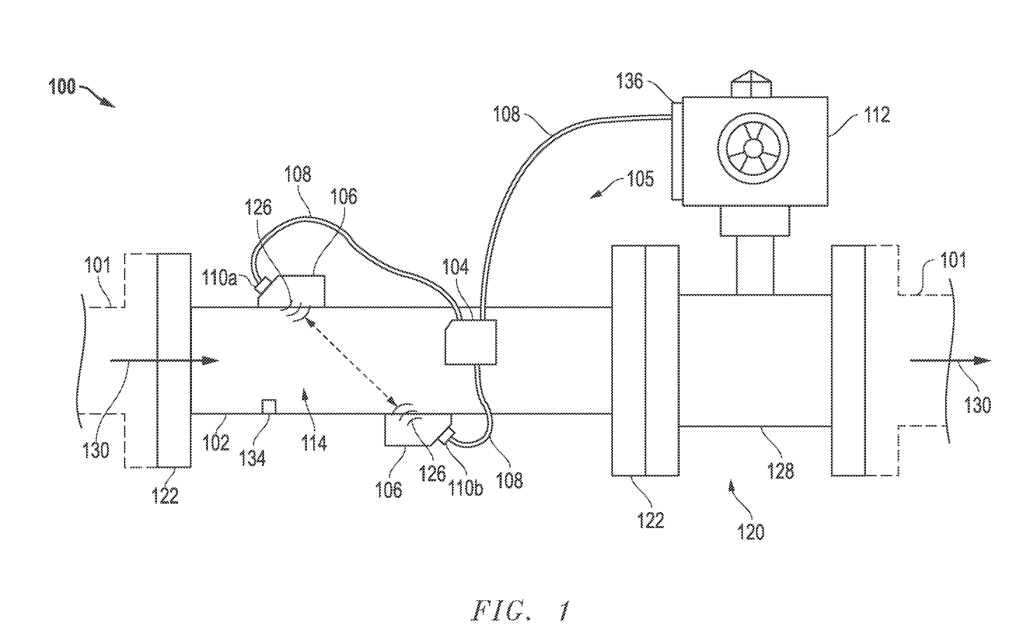

FIG. 1 depicts a schematic side view of one embodiment of a self-correcting closed loop control valve system 100 in which a flow path 130 runs therethrough as part of a pipe system 101. On the upstream end 105 of the valve system 100 and as part of the pipe system 101 is spool or measurement-conduit 102, which defines a flow chamber 114 through which flow path 130 travels into. On the downstream end of valve system 100 is valve assembly 120, through which flow path 130 exits into the remainder of the pipe system 101. The fluid which travels along flow path 130 may be any type of fluid. For example, the fluid may be any fluid typically used within an HVAC system, including, but not limited to: water, or a water/glycol mixture; or the fluid may be any other type of fluid travelling through a pipe system 101.

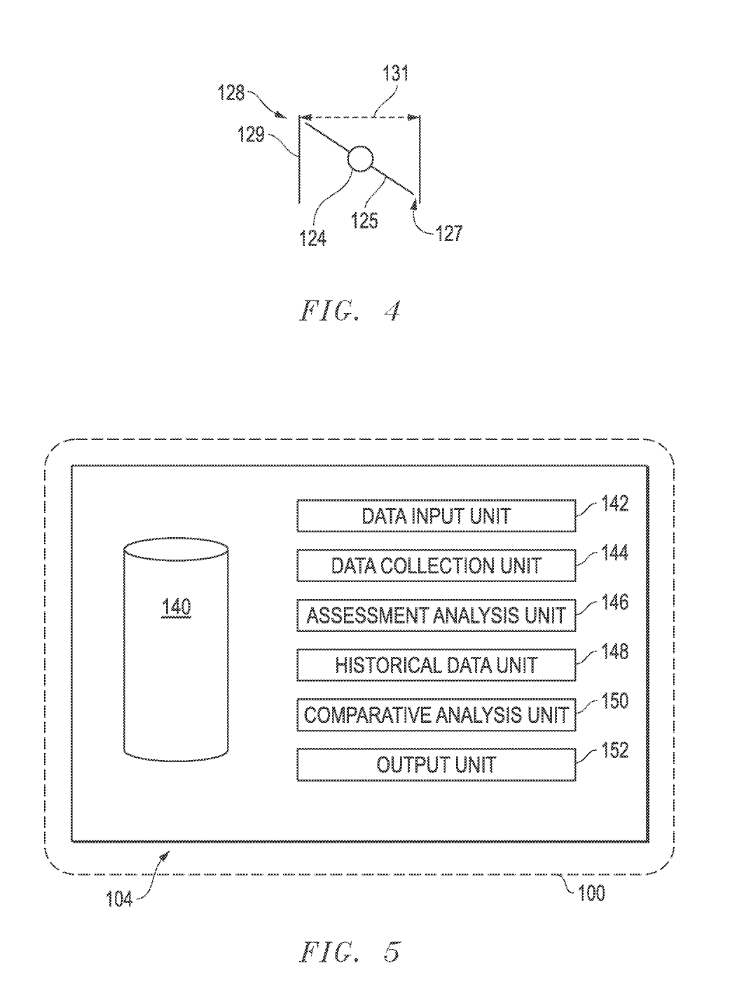

Valve assembly 120 and spool 102 may be coupled together through flange connections 122. Valve assembly 120 includes a valve 128 (which flow path 130 travels therethrough) and an actuator 112. Valve 128 is preferably a butterfly valve 129 (see FIG. 4) although the valve 128 may be any type of valve able to control and gradually modify the flow of a fluid, including, but not limited to ball valves, or any type of valve as best determined by one of ordinary skill in the art. The selection of the valve 128 may be dependent on a desired C, characteristic, or flow coefficient or flow characteristic, curve of the type of valve. By way of example only, a butterfly valve 129 may have a C, curve that is more linear than a ball valve, and as a result may be more desirable to rapidly and easily control the flow rate. In certain exemplary preferred embodiments it is critical or desirable to implement the valve 128 as a butterfly valve 129 to achieve a more linear relationship between the valve opening position and its corresponding C, characteristic. Valve 128 or butterfly valve 129 may be actuated by any type of automated actuator 112 best determined by one of ordinary skill in the art, including, but not limited to: a pneumatic, or electric powered actuator.

With reference to FIG. 4, the valve 128 is represented as a butterfly valve 129. The butterfly valve 129 has a stem 124, a disc 125, and a diameter 131 defined by the opening through the butterfly valve 129. The stem 124, disc 125, diameter 131 and the disc 125 angular position relative to the opening/diameter 131 are all factors in determining a C, characteristic of the butterfly valve 129. In certain exemplary and preferred embodiments it is critical that the valve 128 is a butterfly valve 129. Such a butterfly valve 129 may be a resilient seated butterfly valve commercially available from Bray International, Inc. of Houston, Tex., USA.

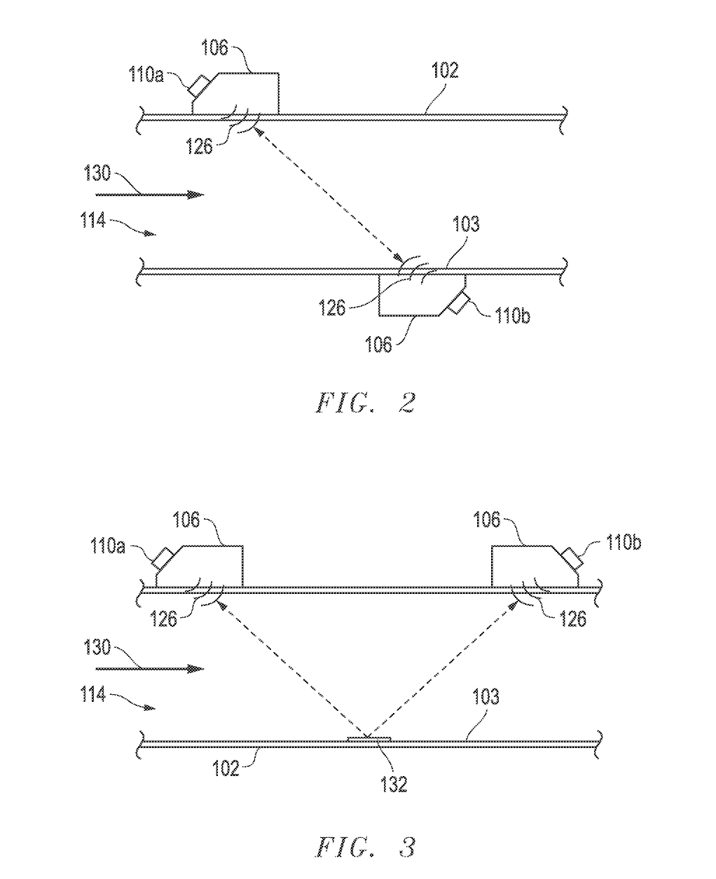

In the embodiment depicted within FIGS. 1-2, two sensors 110a and 110b are positioned diametrically at an angle across the flow chamber 114 of spool 102, in such a way that transmitted and received signals are directed towards the other respective sensor 110a or 110b. Sensors 110a and 110b are retained in sensor supports 106, which are mounted to the external surface of spool 102. Further, sensors 110a and 110b are preferably flush with or slightly recessed into the interior surface 103 of spool 102 so as to not introduce additional disturbance, turbulence or variance into the flow path 130. Sensors 110a and 110b are ultrasonic sensors (comprising an ultrasonic flow meter) capable of both transmitting and receiving signals 126 in the form of ultrasonic waves or vibrations across the flow of fluid in flow chamber 114. The angle at which sensors 110a and 110b are positioned, may be increased or decreased to modify the distance or length traveled by the signal 126 through the fluid medium (the angle can vary depending upon the application e.g.: pipe diameter). Spool 102 may also include temperature sensor(s) 134 to collect and record the fluid temperature and temperature change of flow chamber 114 and/or pipe system 101 and to communicate to an electronic transducer processor 104 (although the temperature sensor(s) may be mounted elsewhere in or connected to the pipe system 101).

To calculate the flow of fluid in the pipe system, the sensor 110a transmits an ultrasonic signal 126 at an angle across the flow path 130 to sensor 110b, which receives the signal 126. The period of time taken by signal 126 to reach a sensor 110a or 110b is affected by the velocity of the fluid in flow path 130. Sensor 110b records the time at which the signal 126 is received, and may also transmit a signal 126 back to sensor 110a. Sensor 110a also records the time at which any second signal 126 is received, and may transmit another signal 126 to sensor 110b. The back-and-forth transmittal and receipt process between the sensors 110a and 110b is continuously, periodically, or intermittently conducted, as desired, while the flow of the pipe system is to be monitored and maintained at a predetermined or preferred flow rate as entered into electronic transducer processor 104. The data regarding the recorded times of transmission and receipt of the signals 126, and the temperature and temperature change of the valve system 100 are used to calculate the flow rate of the fluid in the flow chamber 114.

Wires 108 may carry the data from sensors 110a, 110b, and 134 to electronic transducer processor 104 where the data are collected, recorded, compared, and calculated. Although wires 108 are illustrated within the included drawings, wires 108 are not necessary for communication of the data; wireless communication of the data from the sensors 110a, 110b, and 134 to electronic transducer processor 104 is also envisioned to be a part of the disclosed embodiments.

The electronic transducer processor 104 is generally implemented as electronic circuitry and processor-based computational components controlled by computer instructions stored in physical data-storage components, including various types of electronic memory and/or mass-storage devices. It should be noted, at the onset, that computer instructions stored in physical data-storage devices and executed within processors comprise the control components of a wide variety of modern devices, machines, and systems, and are as tangible, physical, and real as any other component of a device, machine, or system. Occasionally, statements are encountered that suggest that computer-instruction-implemented control logic is “merely software” or something abstract and less tangible than physical machine components. Those familiar with modern science and technology understand that this is not the case. Computer instructions executed by processors must be physical entities stored in physical devices. Otherwise, the processors would not be able to access and execute the instructions. The term “software” can be applied to a symbolic representation of a program or routine, such as a printout or displayed list of programming-language statements, but such symbolic representations of computer programs are not executed by processors. Instead, processors fetch and execute computer instructions stored in physical states within physical data-storage devices. Similarly, computer-readable media are physical data-storage media, such as disks, memories, and mass-storage devices that store data in a tangible, physical form that can be subsequently retrieved from the physical data-storage media.

When electronic transducer processor 104 determines that the flow rate in flow chamber 114 requires adjustment in order to maintain or modify to the desired flow rate or energy usage/transfer, the electronic transducer processor 104 communicates the necessary correction to an electronic controller 136 connected to the actuator 112 of the valve assembly 120 to change the position of valve 128. The electronic controller 136 manipulates the actuator 112 to the desired amount of actuation for the necessary movement of the valve 128 in order to regulate flow rate or volume. Alternatively, the electronic transducer processor 104 can directly communicate to and manipulate the actuator 112 if it is an electronic type actuator (in other words the electronic transducer processor 104 and controller 136 may be combined into a unitary controller as further described below). The control/determination steps may also occur within the electronic transducer processor 104 and/or controller 136, or in combination between the two, despite that the algorithm and associated computational steps are generally discussed as occurring within electronic transducer processor 104 within this disclosure. Upon receipt of instructions from electronic transducer processor 104, the position of valve 128 is adjusted accordingly by actuator 112 such that the flow rate, flow volume or energy use/transfer is maintained at the predetermined, or set rate.

On an ongoing basis for self-correction of valve system 100, the electronic transducer processor 104 processes the learned and sensed information according to one or more advanced control algorithms or calculations, and then automatically adjusts the actuator 112 to a set-point flow rate or energy usage level, and/or to optimize energy usage. The amount of adjustment required can be predicted or inferred by knowing in advance and stored within the memory of the electronic transducer processor 104 or electronic controller 136 the Cᵥ curve/characteristic of the controlling butterfly valve 129. The electronic transducer processor 104 accesses and uses a variety of different types of stored information, data, and inputs, including optionally user/operator input, in order to generate output control commands that control the operational behavior of the electronic controller 136. Such information or data, whether received to the electronic transducer processor 104 by user-input or sensor feedback, includes at least: flow rate feedback from sensors 110a and 110b, temperature feedback from sensor(s) 134, and valve positioning in order to control/determine whether the actuator 112 should change or adjust the valve position so as to maintain a desired or constant flow rate downstream of the valve 120 whilst accounting for, e.g., input pressure changes. Historical data may be a further input into the control/determination in order to improve the efficiency of the self-correcting, “smart” system as implemented input into the algorithm to enhance and optimize dynamic, “real-time”, control of (or ability to maintain a constant) flow rate or energy use/transfer. Additional information used by the electronic transducer processor 104 in its algorithms may include one or more stored control schedules, immediate control inputs received through a control or display interface, and data, commands, and other information received from remote data-processing systems, including cloud-based data-processing systems. In addition to generating control output to manipulate the electronic controller 136, the electronic transducer processor 104 may also provide a graphic or display interface that allows users/operators to easily input data for a desired flow-rate or energy usage level, to create and modify control schedules and may also output data and information to remote entities, other “smart” electronic transducer processors, and to users through an information-output interface.

Operation of the electronic controller 136 will alter the pipe system 101 environment within which sensors 110a, 110b, and 134 are embedded. The sensors return sensor output, or feedback, to the electronic transducer processor 104 through wires 108 or wireless communication. Based on this feedback, the electronic transducer processor 104 modifies the output control commands in order to achieve the specified flow rate or energy usage for the self-correcting closed loop valve system 100. In essence, the electronic transducer processor 104 modifies the output control commands according to two different feedback loops. The first, most direct feedback loop includes feedback from sensors 110a, 110b, and 134 that the electronic transducer processor 104 can use to determine subsequent output control commands or control-output modification in order to achieve the desired flow rate or energy use for the valve system 100. The second feedback loop involves environmental, historical information, or other feedback to users which, in turn, may elicit subsequent user control and inputs to the electronic transducer processor 104. In other words, users can either be viewed as another type of sensor that outputs immediate-control directives and control-schedule changes, rather than raw sensor output, or can be viewed as a component of a higher-level feedback loop.

The electronic transducer processor 104 itself may be mounted onto the external surface of spool 102 as depicted in FIG. 1, or may be located elsewhere within the valve system 100. For example, but not limited to the following: the electronic transducer processor 104 may be physically coupled to the electronic controller 136 or, optionally, the electronic transducer processor 104, electronic controller 136 and/or actuator 112 may be integrated into one physical electronic unit. Moreover, while FIG. 1 depicts an electronic controller 136 mounted on top of actuator 112, electronic controller 136 may be elsewhere located within valve system 100, and may also be combined physically with the actuator 112.

FIG. 5 depicts a schematic view of the valve system 100 including the electronic transducer processor 104 (or the integrated electronic transducer processor 104, electronic controller 136 and/or actuator 112) according to an embodiment. The valve system 100 may have a storage device 140, a data input 142, a data collection unit 144, an assessment analysis unit 146, a historical data unit 148, a comparative analysis unit 150, and an output 152. The storage device 140 may be any suitable storage device for storing data.

In a working example of the adaptive and/or self-learning, predictive functionality of the valve system 100, the electronic transducer processor 104 is in communication with or integrated with the controller 136, and the data input unit 142 may be used to input, for example, but not limited to, the Cᵥ characteristic of the butterfly valve 129. The data collection unit 144 and the historical data unit 148 may be used to input or collect and record, for example but not limited to, data of the flow rate, the temperature, and the valve position of the butterfly valve 129. The comparative analysis unit 150 may be used to compare any or all of the data input 142 with the data collection unit 144 and the historical data unit 148 (for example, to compare historical data with the Cᵥ characteristic of the butterfly valve 129) in order to determine the output 152 in response to the comparative analysis unit 150 and in communication with the controller 136. The optional assessment analysis unit 146 may receive the categorized data from the data collection unit 144 in order to tabulate and/or determine if there is any present or future risk and/or maintenance item likely in the valve system 100. The risk and/or maintenance may be based on real time events that are taking place in the operations and/or based on predictive events that are likely to occur. The assessment analysis unit 104 may classify the risks and/or maintenance for valve system 100.

An alternate arrangement or embodiment of sensors 110a and 110b is depicted in FIG. 3, which may be a more favorable organization of sensors 110a and 110b for smaller diameter pipeline systems. In FIG. 3, the sensor 110a is mounted at angle to transmit a signal 126 against the interior surface 103 of the spool 102. The interior surface 103 of spool 102 then reflects the signal 126 to sensor 110b, which records the time at which the signal 126 is received and transmits another signal 126 to bounce off of the interior surface of spool 102 to sensor 110a. Sensor 110a repeats the same to sensor 110b. The process is repeated continuously, periodically, or intermittently for so long as a regulated flow rate/volume or energy use/transfer of the pipe system is desired. In this embodiment, a reflector 132 may be optionally mounted on the interior surface 103 of spool 102 to assist in the reflection or “bouncing” of the signal 126 to the sensors 110a and 110b.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any valve system or assembly used for piping systems.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A pressure independent control valve system including a pipe system defining a flow path for a volume of fluid to regulate flow downstream of the pressure independent control valve system comprising:
a butterfly valve configured to control a flow rate of the volume of fluid;
an ultrasonic sensor configured to transmit and receive a signal across the flow path; and
an electronic transducer processor in data communication with the ultrasonic sensor and the butterfly valve.

2. The system according to claim 1, wherein the butterfly valve, the ultrasonic sensor and the electronic transducer processor are a closed loop system.

3. The system according to claim 2, wherein the ultrasonic sensor is upstream of the butterfly valve.

4. The system according to claim 3, wherein the ultrasonic sensor comprises at least two ultrasonic sensors.

5. The system according to claim 4, further comprising a spool defining a part of the flow path; and wherein the ultrasonic sensors are mounted in the spool.

6. The system according to claim 5, wherein each of the ultrasonic sensors are positioned diametrically at an angle with respect to each other across the spool.

7. The system according to claim 5, wherein a first ultrasonic sensor is positioned at an angle configured to reflect the signal off of an interior surface of the spool to a second ultrasonic sensor.

8. The system according to claim 1, further comprising:
a controller in data communication with the electronic transducer processor;
a data input configured to input a C, characteristic of the butterfly valve;
a data collection unit and a historical data unit configured to input data of the flow rate, a temperature, and a valve position of the butterfly valve;
a comparative analysis unit to compare the data input with the data collection and the historical data; and
an output configured to respond to the comparative analysis unit and in communication with the controller.

9. The system according to claim 1, wherein the electronic transducer processor is configured to predict an adjustment of a position of a stem of the butterfly valve necessary to maintain the flow rate desired based upon a C, characteristic of the butterfly valve.

10. The system according to claim 1, further comprising a temperature sensor upstream of the butterfly valve.

11. The system according to claim 1, further comprising an actuator connected to the butterfly valve and connected to the electronic transducer processor.

12. A method for maintaining a desired flow rate of a volume of fluid through a fluid flow path in a pressure independent control valve system including a pipe system, comprising the steps of:
transmitting a signal with a first ultrasonic sensor across the flow path;
receiving the signal with a second ultrasonic sensor;
calculating a current flow rate based on the signal;
comparing the current flow rate with the desired flow rate;
basing an adjustment of a position of a stem of a butterfly valve necessary to maintain the desired flow rate based on a C, characteristic of the butterfly valve; and
adjusting the position of the butterfly valve downstream of the first ultrasonic sensor and the second ultrasonic sensor according to said step of basing the adjustment in order to achieve the desired flow rate.

13. The method according to claim 12, wherein said step of basing the adjustment of the position of the stem of the butterfly valve comprises predicting a required position of the stem of the butterfly valve necessary to maintain the desired flow rate based on the Cᵥ characteristic of the butterfly valve and the calculated current flow rate.

14. The method according to claim 12, further comprising the step of collecting a record of the current flow rate.

15. The method according to claim 14, further comprising the step of comparing the current flow rate with the record of the current flow rate.

16. The method according to claim 15, wherein the step of adjusting the position of the butterfly valve comprises the valve system automatically self-adjusting the butterfly valve.

17. The method according to claim 12, further comprising the step of recording a period of time taken by the signal to reach the second ultrasonic sensor.

18. The method according to claim 12, wherein the step of transmitting a signal comprises transmitting the signal at an angle.

19. The method according to claim 18, further comprising the step of reflecting the signal off an interior surface of the pipe system.

20. The method according to claim 14, further comprising the steps of:
sensing a current temperature and collecting the current temperature;
collecting a record of the valve position;
comparing the record of the current flow rate, the collection of the current temperature, the collection of the record of the valve position and the C, characteristic of the butterfly valve; and
outputting based on said step of comparing the record to determine the step of adjusting the position of the butterfly valve.
